(19) United States
(12) Patent Application Publication
(10) Pub. No.: US 2018/0054033 A1
(43) Pub. Date: Feb. 22, 2018

(54) PORTABLE CRIMPING TOOL FOR STRAP

(71) Applicant: Signode Industrial Group LLC, Glenview, IL (US)

(72) Inventors: Wayne J. Skonieczny, JR., Cary, IL (US); Janusz Figiel, Mundelein, IL (US); Jason R. Nasiatka, Northbrook, IL (US)

(21) Appl. No.: 15/679,526

(22) Filed: Aug. 17, 2017

Related U.S. Application Data
(60) Provisional application No. 62/377,039, filed on Aug. 19, 2016.

(51) Int. Cl. H01R 43/042; H01R 43/26

(52) U.S. Cl. CPC H01R 43/0428; H01R 43/26; B25B 27/146; H01R 43/0424; H01R 43/0421

(57) ABSTRACT

A sealing tool for forming a crimp-type joint in a seal positioned on overlapping courses of strap includes a body and a motor and drive train housed in the body. The tool includes an inertia storage element to reduce power consumption. A crimping assembly is mounted to the body and coupled to the motor through the drive train. The crimping assembly includes a pair of opposing jaw elements pivotable toward one another to contact and form crimps in the seal and the strapping material. A guide pin operably connects the drive train to the jaw elements. A side plate encloses the crimping assembly and includes an elongated, slotted opening. A bearing element is mounted to the guide pin and positioned in the slotted opening. The bearing element facilitates movement of the guide pin as it moves through the slotted opening to pivot the jaw elements to the closed position. A seal position element provides indication that the seal is properly positioned in the crimping assembly.

### CROSS-REFERENCE TO RELATED APPLICATION DATA

This application claims the benefit of and priority to Provisional U.S. patent application Ser. No. 62/377,039, filed August 19, 2016, the disclosure of which is incorporated herein in its entirety.

### BACKGROUND

Hand-held, powered sealing tools are used to interlock overlapping courses of a strap into a high strength joint. One type of sealing tool is a crimp-type sealer that forms crimp-type deformations in a seal that is positioned over the overlapping course of strap. These crimp-type sealers press the edges of the strap and the seal into wavy crimps especially shaped to produce maximum frictional forces on the strap.

Unlike sealers that cut into the seal and strap, crimp-type sealers provide maximum strength of the joint without adversely affecting the overall strength of the strapping in that neither the strap nor the seal is cut to form the seal. As such, it will be appreciated that a large force is needed to form the seal, in that the seal as well as the strap must be bent to deform the seal and the overlapping course of strap material.

Pneumatic crimp sealers are known, and while such sealers function well, there are drawbacks. For example pneumatic sealers require a source of compressed air. This limits the mobility of the sealer in terms of location of use, e.g., within a facility, as well as the orientation of use, e.g., along the item to be strapped, due to the compressed air hose connection. In addition, such sealers are quite heavy in that they use air diaphragms or air drives, and require the valve systems necessary to port the compressed air into and out of the drives.

Portable sealers are also known, such as battery powered sealers. However, due to the forces required to form such seals, the power available from known battery operated sealers is limited at best. As such, battery life can be short.

Moreover, in order to form a seal that meets strength requirements it is necessary to properly position the seal within the sealer jaws so that a full and complete seal is made. Incomplete or improper seals due to, for example, the seal shifting sideways in the sealer, can affect seal strength and compromise the integrity of packaged load.

Accordingly, there is a need for a crimp-type sealing tool for strap. Desirably, such a sealing tool is portable to allow use in any location and in any orientation. More desirably, the tool is powered by an installed power source, and can be used on a wide variety of straps and seals in high strength applications, without undue power consumption. More desirably still, such a tool is effectively positioned the seal on the strap, within the tool to assure a complete and proper seal is made.

### SUMMARY

A portable crimp-type sealing tool forms a crimp-type joint in a seal positioned on overlapping courses of strap. The tool includes a body, a motor and drive train housed, at least in part, in the body and a power supply, such as a battery. In an embodiment, the tool includes a controller.

The tool includes a crimping assembly mounted to the body and operably coupled to the motor through the drive train. The crimping assembly includes at least one pair of opposing jaw elements pivotable toward one another from an open position to a closed position, to contact and form crimps in the seal and the overlapping courses of strapping material. In an embodiment, a guide pin operably connects the drive train to the jaw elements.

A side plate encloses the jaw elements and the guide pin. In an embodiment the side plate includes an elongated, slotted opening. An embodiment of the tool includes a bearing element mounted to the guide pin and positioned in the elongated slotted opening. The bearing element facilitates movement of the guide pin as the guide pin moves through the elongated slotted opening to pivot the jaw elements from the open position to the closed position.

In an embodiment of the tool the crimping assembly includes two pairs of opposing jaw elements and a crimper positioned between and operably connecting the pairs of jaw elements. The crimper can include an anvil surface against which the seal is positioned as the jaw elements pivot toward one another.

In an embodiment, the bearing element has an outer diameter that is less than a transverse dimension across the slotted opening. A retaining ring or fastener can be positioned to retain the bearing element mounted to the guide pin. It will be appreciated that other ways in which to retain the bearing element mounted to the guide pin can be used.

An embodiment of the sealing tool includes an inertia storage element. The motor can include an output shaft operably connecting the motor to the drive train, and the inertia storage element can positioned on the motor output shaft. In an embodiment, the inertia storage element is a flywheel. The flywheel can be fixedly mounted to the motor output shaft.

In an embodiment the sealing tool includes a proximity sensor positioned between the opposing jaw elements. The proximity sensor can be operably connected to the controller. In an embodiment, the tool includes a seal edge positioning element. An embodiment of the seal edge positioning element is a lever mounted to the side plate. The lever provides tactile indication that the seal is properly positioned in the crimping assembly. An embodiment of the tool includes a switch and the lever is configured to move into and out of contact with the switch.

An embodiment of the sealing tool includes a proximity sensor configured to detect the presence or absence of the seal positioned in the crimping assembly, and the proximity sensor and the switch are operably connected to the controller such that the presence of a seal in the crimping assembly and proper position of the seal in the crimping assembly are required to actuate the motor. An embodiment of the tool includes a home position switch to sense a position of the jaw elements. In an embodiment, the home position switch senses when the jaw elements are in an open state.

Other objects, features, and advantages of the present disclosure will be apparent from the following description, taken in conjunction with the accompanying sheets of drawings, wherein like numerals refer to like parts, elements, components, steps, and processes.

### DESCRIPTION OF THE DRAWINGS

FIG. 1 is a side view of an embodiment of a portable crimp-type sealing tool;

FIG. 2 illustrates an example of a crimp seal on overlapping courses of strapping material;

FIG. 3 is a partially exploded view of the sealing tool;

FIG. 4 is a perspective side view of an embodiment of the tool with portions of the outer case removed for ease of illustration;

FIG. 5 is partial perspective view of the crimping assembly

FIG. 6 is view similar to FIG. 5 with a crimping assembly side plate removed for clarity of illustration;

FIG. 7 is another illustration of the crimping assembly;

FIG. 8 is a view of a portion of the crimping assembly; and

FIG. 9 is still another illustration of the crimping assembly showing an embodiment of the seal edge positioning element.

### DETAILED DESCRIPTION

While the present disclosure is susceptible of embodiment in various forms, there is shown in the drawings and will hereinafter be described one or more embodiments with the understanding that the present disclosure is to be considered illustrative only and is not intended to limit the disclosure to any specific embodiment described or illustrated.

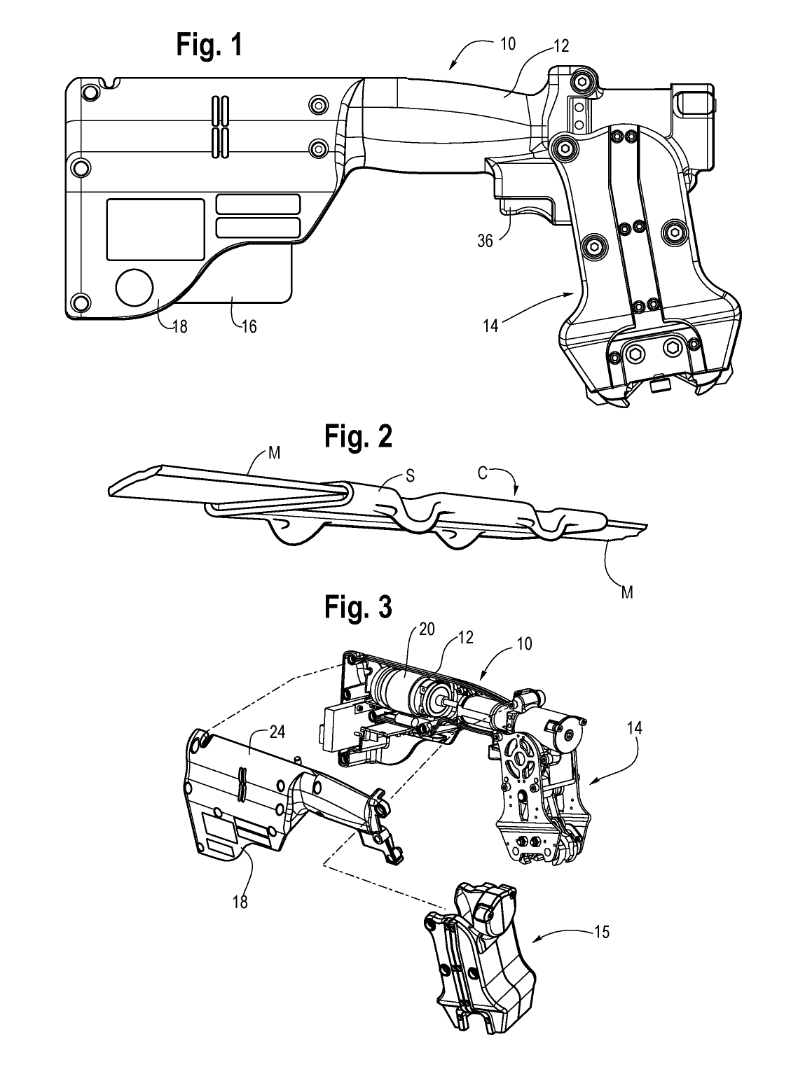

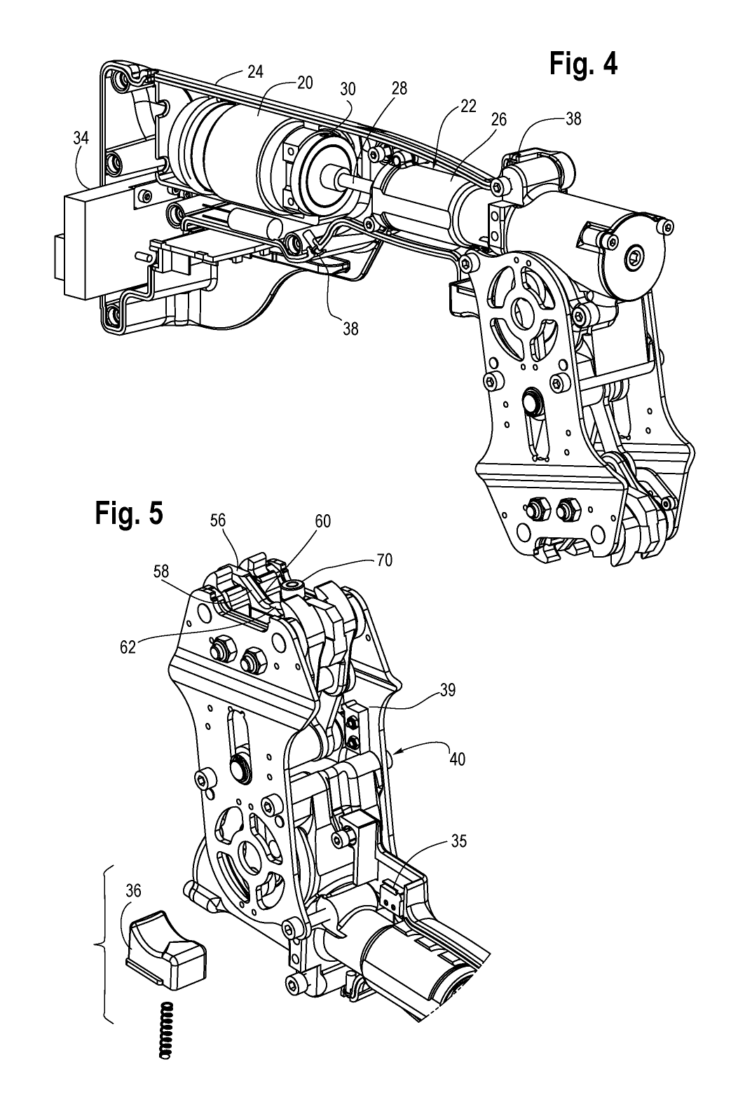

FIG. 1 illustrates an embodiment of a portable crimp-type sealing tool or sealer 10. As illustrated in FIG. 2, the sealing tool 10 is used to form bends or crimps C in a seal S that is positioned on overlapping courses of strap material M. Crimp type seals S are used in applications that require high strength, high integrity joints, such as in securing loads in the holds of ships, to prevent the loads from shifting during transport.

The tool 10 includes generally a body 12, a sealing or crimping head 14 and a power supply 16, such as a battery. The battery 16 is positioned in a battery receiver 18 on the body 12. A motor 20 and drive train 22 are mounted within the body 12. The tool 10 includes an outer housing or case 24. The drive train 22 includes a gear set 26 to convert the high speed output (e.g., about 28,000 rpm) of the motor 20 into increased output power or torque to drive the sealing components in the sealing head 14. It will be appreciated that motor 20 speed can vary and that motors of such varied speeds can be used (for example, it is anticipated that motors with speeds as low as 6000 rpm can be used). In an embodiment, the motor 20 includes an output shaft 28 that is operably connected to the gear set 26 and an inertia storage element 30. In an embodiment, the inertia storage element 30 is a flywheel that is mounted to the output shaft 28 to rotate with the shaft 28. The gear set 26 can be, for example, a planetary gear set mounted to a linear output or worm gear 32.

An embodiment of the tool 10 includes a controller 34, an actuation switch 35 that is actuated by a trigger button 36 and one or more status indicators 38, such as LED indicators to indicate the status of the tool. In an embodiment, the tool 10 includes a home position switch 39. A cover 15 can be positioned over the sealing head 14.

A crimper assembly 40 is operably connected to the gear set 26, at the linear gear 32. In an embodiment, the crimper assembly 40 includes a drive gear 42 that meshes with the linear gear 32. A first link 44 is eccentrically mounted to the drive gear 42 by a first pin 46. A pair of link arms 48a,b are pivotally mounted to the first link 44 by a second pin 50. The assembly 40 includes at least one pair of jaw elements 52a,b. In an embodiment, the assembly 40 includes multiple pairs, e.g., two pairs, 52a,b and 53a,b, of jaw elements. Each pair 52, 53 of jaw element includes opposing or facing jaw elements 52a, 53a and 52b, 53b and each jaw element is pivotally mounted to a respective link arm 48a,b by respective third pins 54a,b. Each pair of jaw elements 52a,b and 53a,b forms a pair of opposing bends or crimps C in the seal S and strap M.

The jaw elements 52a,b and 53a,b are mounted to, and operably connected to each other by one or more crimpers 56. The crimper 56 include a pair of slopes faces 58, a central region 60 between the sloped faces that includes an upstanding anvil surface 62 against which the seal S is bent during crimping. In an embodiment in which the assembly 40 includes two pairs of jaw elements 52, 53, the assembly 40 includes a crimper 56 between and separating the jaw element pairs 52, 53.

The jaw elements 52a,b and 53a,b are mounted to the crimper 56 by respective fourth pins 64. In this configuration, as the worm gear 32 rotates, it rotates the drive gear 42. A first end 66 of the first link 44 rotates eccentrically with the drive gear 42 which in turn moves a second end 68 of the first link 44 in a generally reciprocating manner. The link arms 48a,b, which are mounted pivotally to the second end 68 of the first link 44, move in a generally downward and outward arc, which in turn open and close the jaws 52a,b and 53a,b.

In an embodiment the tool 10 includes a proximity sensor 70. The proximity sensor 70 senses the presence or absence of a seal S in the crimping assembly 40. In an embodiment, the sensor 70 is positioned between the jaw elements 53a,b of one of the pairs of jaw elements and adjacent to the crimper 56. Other locations or positions for the proximity sensor 70 will be recognized by those skilled in the art.

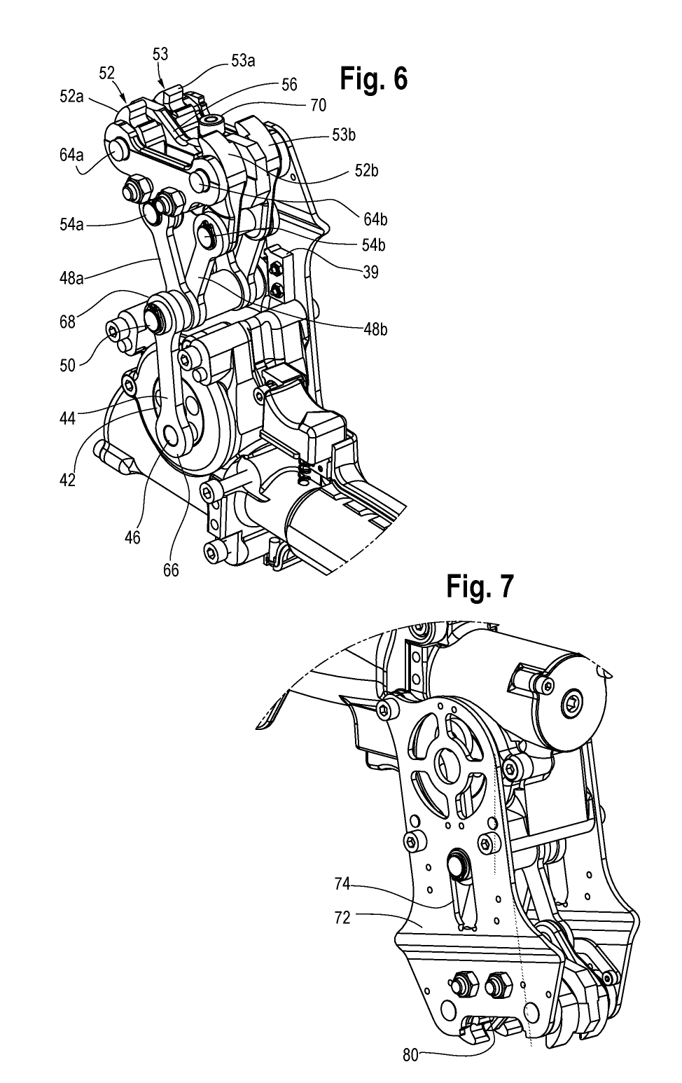

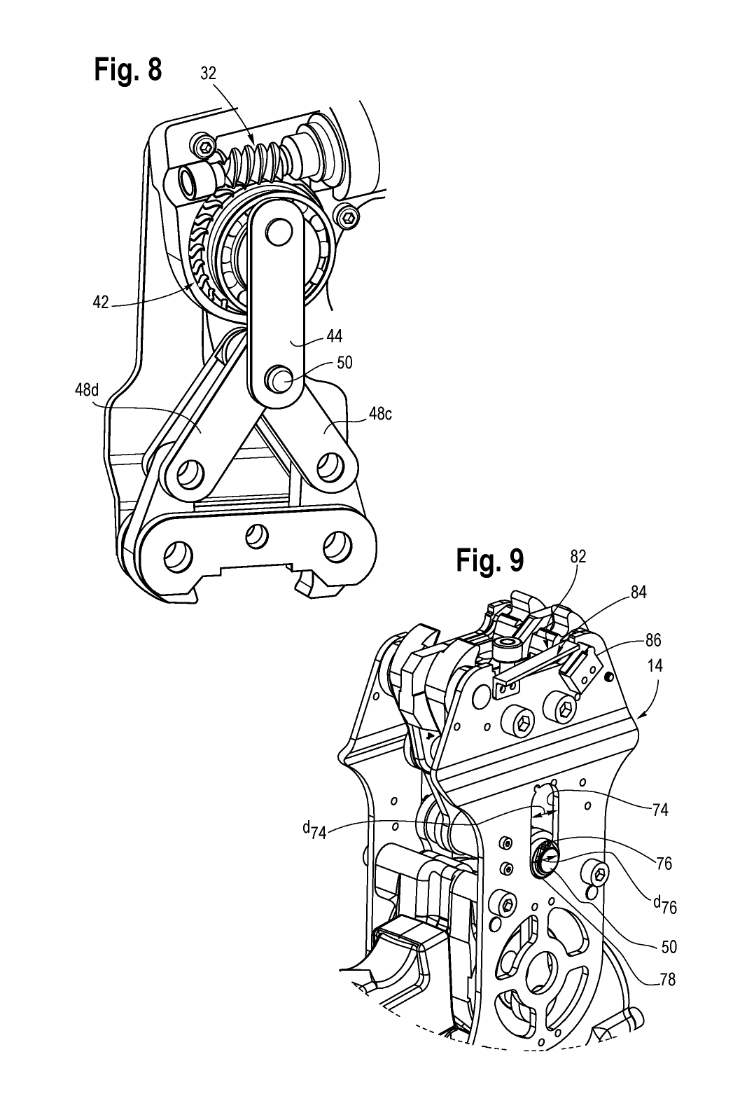

Referring to FIGS. 5-7, in an embodiment, the crimping assembly 40 includes a pair of side plates 72 that contain the drive gear 42, the jaw elements 52, 53, link 44 and link arms 48a,b and the crimper 56. In an embodiment, the side plates 72 include an elongated slotted opening 74 and the second pin 50 extends through the opening 74 to guide the second end 68 of the first link 44 and the first ends 66 of the link arms 48a,b in a reciprocating path as the tool 10 moves through the crimping cycle. To reduce the losses due to friction and to ease or smooth the movement of the link arms 48a,b and the second pin 50, in an embodiment, the second pin 50 includes a bearing element 76. The bearing element 76 can be, for example, a guide roller or like bearing mounted to an end of the pin 50 or to the body of the pin near an end thereof In the illustrated embodiment, the bearing or guide roller 76 is retained in place by a fastener or retaining ring 78. It will be appreciated that other ways in which to retain the bearing element 76 mounted to the guide pin 50 can be used. For example, although not shown, a cap can be positioned on the pin 50 to retain the bearing 76 in place a cap can be positioned on the side plate or plates 72 to retain the bearing 76 in place, or a closed side plate or plates 72 can be used to retain the bearing 76 in place. All such configurations are within the scope and spriti of the present disclosure. The guide roller 76 is sized so as to freely move through the side plate slotted opening 74. In an embodiment, the slotted opening 74 is dimensioned, as shown generally at d₇₄ slightly larger than an outside diameter D₇₆ of the guide roller 76 so that the roller 76 moves freely through the opening 74.

In an embodiment, the side plates include a cut-out or recess 80 at about the jaws 52a,b and 53a,b. The cut-out 80 is configured to position the seal S and strap M relative to the jaws 52a,b and 53a,b and crimper 56 and to provide a seat for the seal S and strap M during the crimping cycle. However, as noted above, the seal S can be improperly positioned transverse to the jaws 52a,b and 53a,b and crimper 56 by sliding along the cut-out 80 in the side plates 72. In order to assure proper transverse positioning of the seal S during the crimping cycle, the tool 10 can include a seal edge positioning element 82. In an embodiment, the seal edge positioning element 82 includes a catch lever 84 mounted to the side plate 72 adjacent to the cut-out 80. The catch lever 84 can be a mechanical catch that is configured such that the seal S abuts the lever 84 and provides tactile indication that the seal S is properly positioned in the cut-out 80. The lever 84 can be, for example, a spring steel member mounted to the side plate 72, or a steel element pivotally mounted to the side plate by a spring (not shown). In such a configuration, the user is assured of proper seal S position by abutting the edge of the seal S against the lever 84.

Alternatively, the seal edge positioning element can include a switch 86, such as an electro-mechanical switch that works in conjunction with, for example, a lever 84, to provide positive indication that the seal S is properly positioned in the tool 10. In such an embodiment, for example, the lever 84 can move into contact with the switch 86 when the seal S is pressed on the lever 84, and the lever 84 can move away from the switch 86 when the lever 84 is abutting an edge of the seal S (similar to the mechanical tactile indicator configuration) to indicate that the seal S is properly positioned for the crimping cycle. In such an embodiment, the switch 86 may also be operably connected, for example, through the controller 34 or control circuitry, to the proximity sensor 70 to permit operation of the tool 10 when the sensor 70 senses the presence of a seal S in the crimping assembly 40 and when the switch 86 indicates that the seal S is properly positioned in the side plate cut outs 80.

In use, the tool 10 is in a home or open state, with the jaw elements 52a,b and 53a,b open or rotated outwardly, ready to receive a seal S and strapping material M (the jaws 52, 53 are positioned so that a seal can be positioned in the tool 10). The seal S is positioned in the tool 10 in the side plate cut outs 80. In an embodiment in which the tool 10 includes the seal edge positioning element 82, the seal S edge is positioned against the positioning element 82. The trigger button 36 is depressed, which actuates or closes the trigger switch 35, which in turn sends a signal to the control to provide power to the motor 20. The motor 20 actuates to drive the worm gear 32, which in turn rotates the drive gear 42. Rotation of the drive gear 42 in turn reciprocates the first link 44 and link arms 48a,b, which pivot the jaw elements 52a,b and 53a,b inwardly onto and crimping the crimp seal S against the anvil surface 62.

In an embodiment in which the tool 10 includes a proximity sensor 70, the sensor 70 sends a signal to the controller 34 to indicate the presence or absence of a seal S in the tool 10 against the crimper anvil surface 62. In the absence of a signal or in the absence of a seal on the crimper anvil surface, the controller 34 will not allow motor 20 to actuate. And, in an embodiment in which the seal edge positioning element 82 includes a switch 86, the switch 86 generates a signal to the controller 34 to allow operation only when the switch 86 senses that the seal S is properly positioned relative to the side plates 72. The seal edge positioning element switch 86 and the proximity sensor 70 may be used in conjunction with one another to assure both the presence of a seal S on the crimper anvil surface 62 and the proper positioning of the seal S relative to the side plates 72. In such an embodiment both signals, that is presence of a seal S and proper position of the seal S, must be indicated for the motor 20 to actuate.

In an embodiment in which the tool 10 includes a home position switch 39, the switch 39 senses when the jaw elements 52a,b and 53a,b are in the home or open state and sends a signal to the controller 34 to allow the tool 10 to operate (to move through a sealing cycle) when the jaw elements 52a,b and 53a,b open or rotated outwardly, ready to receive a seal S and strapping material M.

The tool 10 may also include wireless communication protocols to control and/or monitor the functions and operations of the tool 10. In addition, in an embodiment, the tool 10 includes electronic controls, such as an electronic brake that is used to, for example, isolate power from the motor 20. It will be appreciated that all or individually and independently, any of the sensing and control features may be included in an embodiment of the tool 10.

As noted above, the inertia storage element 30, which in an embodiment is a weighted flywheel, is mounted to the motor output shaft 28 to rotate with the shaft 28. The flywheel 30 stores energy from the initial tool 10 start up to use during the crimping cycle. That is, the flywheel 30 provides momentum, e.g., an inertial force, to the gear set 26. In this manner, power from the battery 16 can be isolated prior to the end of the crimping cycle, to reserve battery 16 power, while the momentum of the flywheel 30 continues to transfer power to the gear set 26 and ultimately to the jaw elements 52a,b and 53a,b to form the seal. The flywheel 30 also increases the overall power/torque of the tool 10 at output.

It will be appreciated by those skilled in the art that the relative directional terms such as sides, upper, lower, rearward, forward and the like are for explanatory purposes only and are not intended to limit the scope of the disclosure.

All patents referred to herein, are hereby incorporated herein by reference, whether or not specifically done so within the text of this disclosure.

In the present disclosure, the words “a” or “an” are to be taken to include both the singular and the plural. Conversely, any reference to plural items shall, where appropriate, include the singular.

From the foregoing it will be observed that numerous modifications and variations can be effectuated without departing from the true spirit and scope of the novel concepts of the present disclosure. It is to be understood that no limitation with respect to the specific embodiments illustrated is intended or should be inferred. The disclosure is intended to cover all such modifications as fall within the scope of the claims.

What is claimed is:

1. A sealing tool for forming a crimp-type joint in a seal positioned on overlapping courses of strap, comprising:
a body;
a motor and drive train housed, at least in part, in the body;
a power supply;
a controller; and
a crimping assembly mounted to the body and operably coupled to the motor through the drive train, the crimping assembly including
at least one pair of opposing jaw elements pivotable toward one another from an open position to a closed position, to contact and form crimps in the seal and the overlapping courses of strapping material,
a guide pin operably connecting the drive train to the jaw elements, and
a side plate enclosing the jaw elements and the guide pin, the side plate including an elongated, slotted opening,
wherein the guide pin as the guide pin moves through the elongated slotted opening to pivot the jaw elements from the open position to the closed position.

2. The sealing tool of claim 1 including a bearing element mounted to the guide pin and positioned in the elongated slotted opening, to facilitate movement of the guide pin through the slotted opening.

3. The sealing tool of claim 1, wherein the crimping assembly includes two pairs of opposing jaw elements, and including a crimper positioned between and operably connecting the pairs of jaw elements.

4. The sealing tool of claim 3, wherein the crimper includes an anvil surface against which the seal is positioned as the jaw elements pivot toward one another.

5. The sealing tool of claim 1, wherein the bearing element has an outer diameter that is less than a transverse dimension across the slotted opening.

6. The sealing tool of claim 1 including a fastener or retaining ring to retain the bearing element mounted to the guide pin.

7. The sealing tool of claim 1 including an inertia storage element.

8. The sealing tool of claim 7, wherein the motor includes an output shaft operably connecting the motor to the drive train, and wherein the inertia storage element is positioned on the motor output shaft.

9. The sealing tool of claim 8, wherein the inertia storage element is a flywheel.

10. The sealing tool of claim 9, wherein the flywheel is fixedly mounted to the motor output shaft.

11. The sealing tool of claim 1 including a proximity sensor positioned between the opposing jaw elements.

12. The sealing tool of claim 11, wherein the proximity sensor is operably connected to the controller.

13. The sealing tool of claim 1 including a seal edge positioning element.

14. The sealing tool of claim 13, wherein the seal edge positioning element is a lever mounted to the side plate.

15. The sealing tool of claim 14, wherein the lever provides tactile indication that the seal is properly positioned in the crimping assembly.

16. The sealing tool of claim 14 including a switch, wherein the lever is configured to move into and out of contact with the switch.

17. The sealing tool of claim 16 including a proximity sensor configured to detect the presence or absence of the seal positioned in the crimping assembly, and wherein the proximity sensor and the switch are operably connected to the controller such that the presence of a seal in the crimping assembly and proper position of the seal in the crimping assembly are required to actuate the motor.

18. The sealing tool of claim 1 including a home position switch to sense a position of the jaw elements.

19. The sealing tool of claim 18, wherein the home position switch senses when the jaw elements are in an open state.

20. The sealing tool of claim 17 including a home position switch to sense when the jaw elements are in an open state.
